(19) United States
(12) Patent Application Publication
(10) Pub. No.: US 2011/0191064 A1
(43) Pub. Date: Aug. 4, 2011

(54) PLANT MEASUREMENT CONTROL DEVICE AND METHOD

(76) Inventor: Hisayoshi Fukai, Tokyo (JP)

(21) Appl. No.: 13/122,029

(22) PCT Filed: Sep. 30, 2009
(86) PCT No.: PCT/JP2009/067064

§ 371 Date: Apr. 26, 2011

(30) Foreign Application Priority Data
Oct. 2, 2008 (JP) 2008-257477

(51) Int. Cl. G06F 15/00

(52) U.S. Cl. 702/183

(57) ABSTRACT

[Object] To provide a device and a method that can carry out maintenance, such as check and replacement of sensors in a plant and the like, without isolation of a system even while a plant is operated.

[Solution] A plant measurement control device, wherein a measurement signal of each on-site sensor provided at every operation terminal in a plant is transmitted to a central operation room and operation of the operation terminals is performed from the central operation room, the on-site sensor 1 including a self-diagnosis means for diagnosing a function of the on-site sensor, a wireless LAN communication means 13 for transmitting a detection signal of the on-site sensor through a wireless LAN, and a lasting electric power source 11 for supplying each of the means with electricity.

### TECHNICAL FIELD

The present invention relates to a plant measurement control device and method, and in particular, to a device and method for performing measurement control by using complete wireless communication with important sensors in a measurement control system in a plant whose operation rate is desired to be increased, such as a nuclear power plant.

### BACKGROUND ART

First, an example of a measurement control system included in a normal plant will be described with reference to FIG. 4. In FIG. 4, an on-site sensor 1 receives a power supply from an instrumentation power source 2, converts a measurement value (electric current) to a voltage signal by a current-voltage converter 3, and transmits the signal to an arithmetic unit 4, a control device 5, and an indicator/recorder 6.

Each means in a path through which an operation signal is outputted from the control unit 5 to a valve 9, which is an operation terminal, via an operation panel 7 in a central operation room and an on-site operation panel 8 are formed as an analog loop connected by electrical cables.

An on-site sensor device for a conventional nuclear power plant or the like is used as described above, and the measurement control system is checked periodically to ensure its quality and safety. When the plant is stopped for the periodical check, a system separation (isolation) is performed to ensure the safety, and then the check is performed.
Patent Document 1: Japanese Patent Application Laid-Open (JP-A) No. 10-148694
Patent Document 2: Japanese Patent Application Laid-Open (P-A) No. 2001-94970

### DISCLOSURE OF THE INVENTION

### Problems to be Solved by the Invention

However, the separation operation of the system imposes a large burden on the plant operator. Further, these sensors impose a huge burden on a plant construction work or a facility improvement work in terms of cost and period of the installation work and the usage of the sensors.

In addition, for on-site work in a nuclear power plant or the like, workers' health and safety against radiation exposure are desired to be improved, so that, in a facility repair/improvement work, there is a need for the on-site sensors that can be relatively easily expanded or multiplexed.

The present invention is made in view of the above points, and an object of the present invention is to provide a device and a method that can carry out maintenance, such as check and replacement of sensors in a plant and the like, without isolation of a system even while a plant is operated.

### Means for Solving the Problems

To achieve the above object, the present invention provides a device and method described below.

The device is a plant measurement control device, wherein a measurement signal of each on-site sensor provided at every operation terminal in a plant is transmitted to a central operation room and operation of the operation terminals is performed from the central operation room,

the on-site sensor including:

a self-diagnosis means for diagnosing a function of the on-site sensor;

a wireless LAN communication means for transmitting a detection signal of the on-site sensor through the wireless LAN; and

a lasting electric power source for supplying each of the means with electricity.

The method is a plant measurement control method, wherein a measurement signal of each on-site sensor provided at every operation terminal in a plant is transmitted to a central operation room, and operation of the operation terminals is performed from the central operation room,

the on-site sensor comprising:

providing the on-site sensor with a self-diagnosis function;

transmitting a detection signal of the on-site sensor through a wireless LAN; and

supplying the on-site sensor with electricity from a lasting electric power source.

### Effect of the Invention

As described above, in the present invention, a microcomputer having a self-diagnosis function, a lasting electric power source, and a wireless LAN device are combined with the on-site sensor and they are integrated all together, so that a measurement control device in which no electrical cable connection is required can be configured.

### BRIEF DESCRIPTION OF THE DRAWINGS

FIG. 1 is an entire configuration diagram showing a configuration of a first embodiment of the present invention.

FIG. 2 is an illustration showing an internal configuration of an on-site device shown in FIG. 1.

FIG. 3 is an illustration showing an example of attaching the on-site sensor shown in FIG. 1 to an object.

FIG. 4 is a block diagram showing an entire configuration of a conventional system.

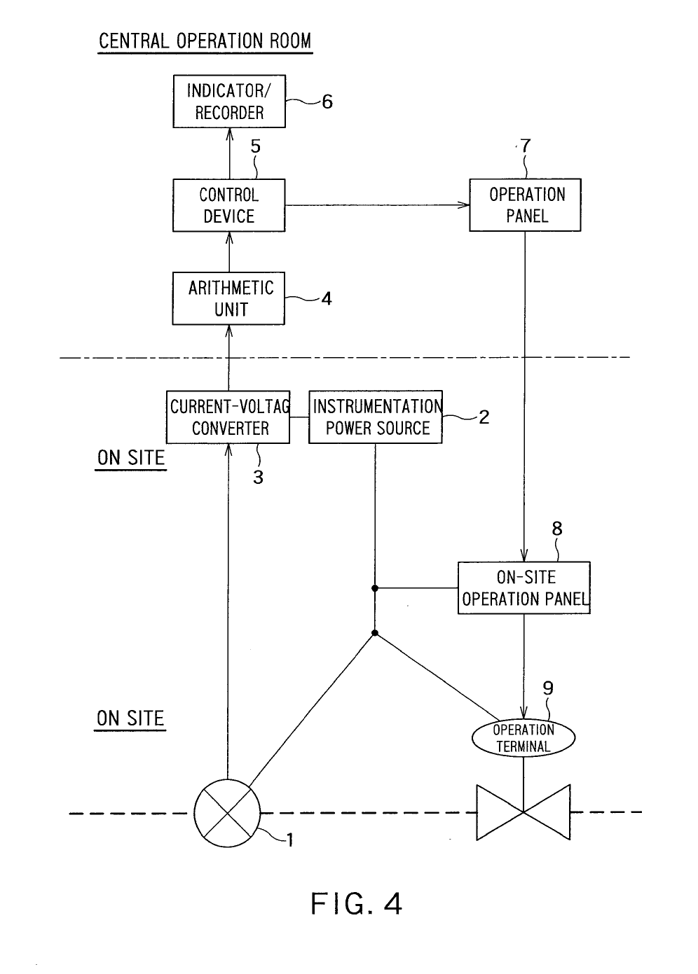

### BEST MODE FOR CARRYING OUT THE INVENTION

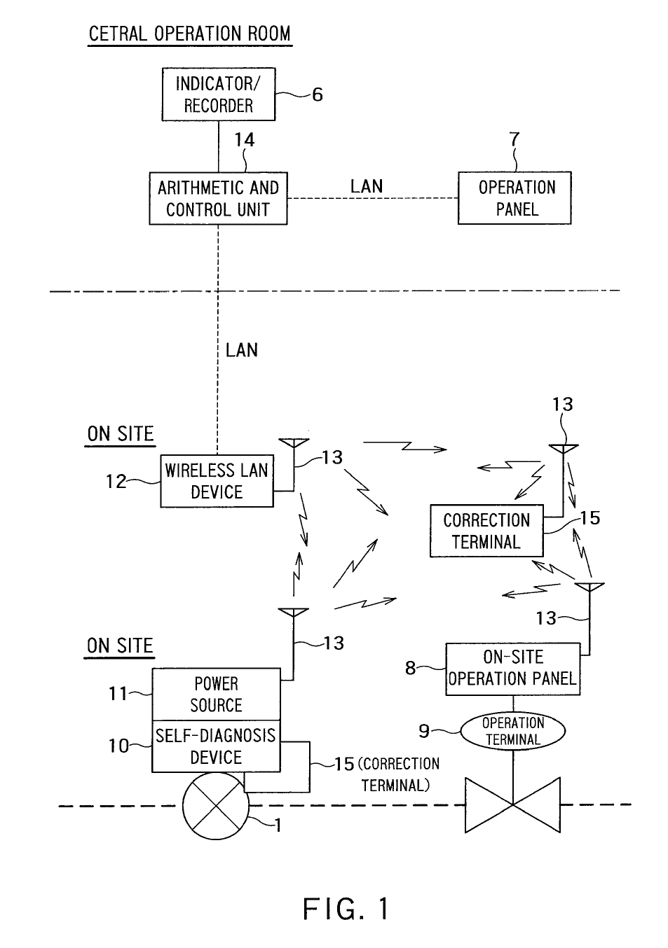

Hereinafter, embodiments of the present invention will be described with reference to FIGS. 1 to 3.

### First Embodiment

FIG. 1 shows a first embodiment of the present invention. As shown in FIG. 1, the on-site sensor 1 is integrated with a self-diagnosis device 10, such as a microcomputer, having a self-diagnosis function; a lasting electric power source 11, for example, a home electric generator; and a wireless LAN antenna 13. The on-site sensor 1 is connected to an arithmetic and control unit 14, an indicator/recorder 6, and an operation panel 7 through a LAN via a wireless LAN device 12. An operation signal from the operation panel 7 is provided to an on-site operation panel 8 and an operation terminal 9 via the wireless LAN device 12.

Here, the self-diagnosis function of the self-diagnosis device 10 indicates functions of (a) to (d) described below.

(a) A watchdog timer (WDT) function of a CPU (central processing unit) for monitoring whether the arithmetic unit operates normally.

(b) A power source monitoring function for reading a driving voltage of the self-diagnosis device and monitoring whether or not there is an abnormality.

(c) A function for checking soundness of an I/O unit by monitoring a signal from the sensor or a voltage value divided from the power source.

(d) A monitoring function for detecting abnormality of the measurement environment having a temperature sensor, a humidity sensor, and the like for self-monitoring incorporated into a main body.

According to the first embodiment configured as described above, the on-site sensor 1 is completely unwired, and a measurement/control signal is wirelessly transmitted by a wireless LAN as a digital signal instead of an analog signal transmitted by a conventional electrical cable. Therefore, when checking the on-site sensor 1, it is possible to use software to perform safety treatment and a checking operation of the sensor.

Further, it is possible to easily construct a double on-site sensor system including devices of a higher level LAN. Here, detection targets of the on-site sensors are pressure, temperature, revolution, vibration, radiation, electrical potential, and the like.

Since the on-site sensor is completely unwired, the cost of material and construction work can be largely reduced by eliminating cables of the on-site sensors.

Since the on-site sensor is unwired and a higher level control system from a wireless LAN relay station is configured by a wired LAN, when a sensor to be checked and corrected needs to be disconnected from the system, the sensor can be disconnected by software. Accordingly, it is possible to perform a check and maintenance of the sensor without stopping the periodical check of the plant.

### Second Embodiment

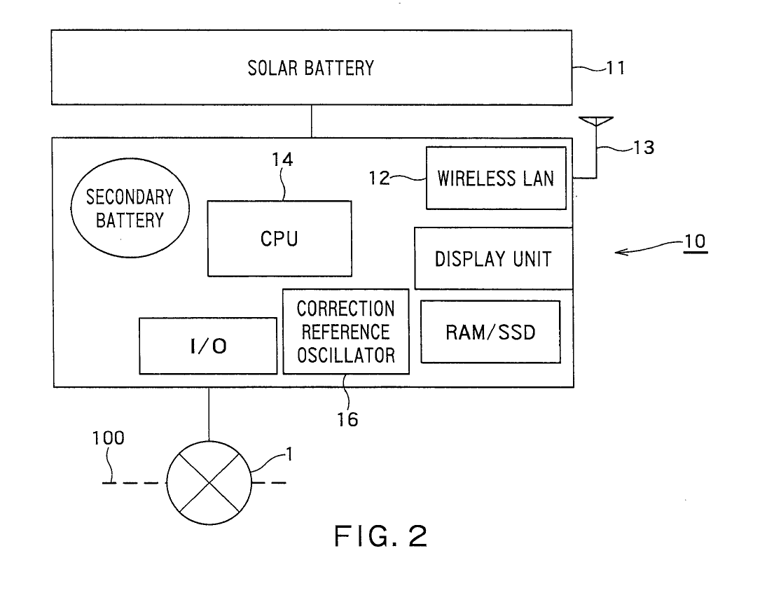

FIG. 2 shows a second embodiment of the present invention showing a configuration of the on-site device. As shown in FIG. 2, the on-site sensor 1 includes a self-diagnosis device 10, a power source 11 such as a solar battery, a wireless LAN device 12, a wireless LAN antenna 13, a CPU 14, a correction terminal 15, and a correction reference oscillator 16. The on-site sensor 1 has a function for detecting abnormality of a measured process value and determining systematic abnormality in addition to the self-diagnosis function.

Here, the function for detecting abnormality of a process value and the function for determining systematic abnormality are as described below.

First, the function for detecting abnormality of a process value indicates a function for detecting disconnection of a signal from a detector, detecting earth fault of a signal from the detector, and detecting abnormality of the rate of change of a signal from the detector.

The function for determining systematic abnormality has a function for monitoring/determining a systematic change by determining a process value by a microcomputer using software, and has a distributed monitoring function.

The on-site sensor 1 is disposed on a pipe 100 of a plant which is a measurement object, and measures physical amounts necessary to manage the plant, such as pressure, temperature, revolution, vibration, radiation, electrical potential, and the like of the pipe 100.

The operation terminal 9 (FIG. 1) is provided to the same pipe 100 for opening and closing a valve, and open and close operations of the operation terminal 9 is performed from the on-site operation panel 8 (FIG. 1). The on-site operation panel 8 is corrected by the correction terminal 15 (FIG. 1).

Each self-diagnosis device 10 can independently exert functions and perform operations, and includes the wireless LAN antenna 13 so as to be wirelessly connected with each other. As a result, the measurement control system can be operated without intervention of a human being, so that a distributed monitoring having advantages in quality and safety can be performed.

### Other Embodiments

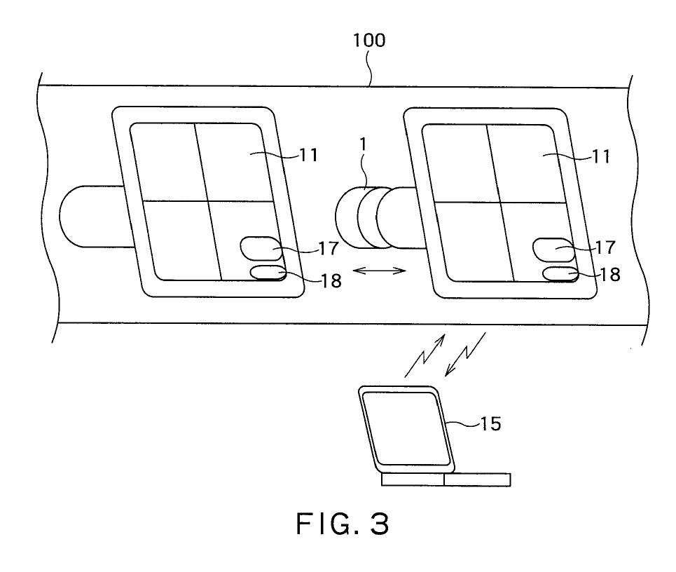

FIG. 3 shows a situation in which an on-site sensor 1 is in contact with a pipe 100 and a periodical check is performed. The on-site sensor 1 includes a distributed control panel as shown in FIG. 2. The on-site sensor 1 may determine control of the on-site sensor itself, and also perform distributed control in which a measurement signal is transmitted to the distributed control panel to operate the operation terminal.

In the on-site sensor 1 of a measurement control system included in a plant, a reference device correction function such as a correction crystal oscillator or a standard weight, or a test terminal may be built-in in advance.

An IP address may be provided to each on-site sensor 1 of a measurement control system included in a plant so that every on-site sensor has a multiplexed backup function.

By building in a reference device correction function such as a correction crystal oscillator or a standard weight, or a test terminal in the on-site sensor 1 of a measurement control system included in a plant in advance, it is possible to reduce on-site work load when checking and correcting the sensor as well as to reduce the amount of radiation exposure of workers in a nuclear power plant or the like.

By connecting the on-site sensors of a measurement control system included in a plant and a higher level controlling/monitoring/operating system by a LAN, it is possible to increase flexibility in additional sensors, improvement of control function, remote monitoring, and the like. By configuring the measurement control system using LAN, high scalability of the device configuration can be achieved.

By configuring the measurement control system using LAN, safety treatment of the on-site sensor can be performed by using software when checking the on-site sensor. Therefore, it is possible to perform maintenance of the on-site sensor during operation of the plant, and thus the operation rate of the plant can be improved.

Further, an IP address may be provided to each on-site sensor of a measurement control system included in a plant so that every on-site sensor can have a multiplexed backup function.

In addition, since the on-site sensors can be managed by software, it is possible to easily construct a multiplexed on-site sensor system including devices connected to a higher level LAN, and thus the reliability of the plant improves.

### DESCRIPTION OF REFERENCE NUMERALS

1 . . . on-site sensor, 2 . . . instrumentation power source, 3 . . . current-voltage converter, 4 . . . arithmetic unit, 5 . . . control device, 6 . . . indicator/recorder, 7 . . . operation panel, 8 . . . on-site operation panel, 9 . . . operation terminal/valve, 10 . . . microcomputer, 11 . . . power source, 12 . . . wireless LAN unit, 13 . . . wireless LAN antenna, 14 . . . arithmetic/control unit, 15 . . . correction terminal

1. A plant measurement control device, wherein a measurement signal of each site sensor provided at every operation terminal in a plant is transmitted to a central operation room and operation of the operation terminals is performed from the central operation room,
the site sensor comprising:
a self-diagnosis means for self-diagnosing a function of the site sensor;
a wireless LAN communication means for transmitting a detection signal of the site sensor through a wireless LAN; and
a lasting electric power source for supplying each of the means with electricity.

2. The plant measurement control device according to claim 1, wherein the on-site sensor has an abnormality detection function of a measured process value and a detection function of systematic abnormality in addition to a self-diagnosis function, and the on-site sensor individually performs distributed monitoring.

3. The plant measurement control device according to claim 1 comprising:
a distributed control panel installed on site,
wherein the on-site sensor determines control of the on-site sensor itself and performs distributed control in which a measurement signal is transmitted to the distributed control panel to operate the operation terminal.

4. The plant measurement control device according to claim 1, wherein a correction function means or a test terminal is built in the on-site sensor.

5. The plant measurement control device according to claim 1, wherein the on-site sensor has an IP address, and the on-site sensor individually has a multiplexed backup function.

6. A plant measurement control method, wherein a measurement signal of each on-site sensor provided at every operation terminal in a plant is transmitted to a central operation room and operation of the operation terminals is performed from the central operation room,
the on-site sensor comprising:
providing the on-site sensor with a self-diagnosis function;
transmitting a detection signal of the on-site sensor through a wireless LAN; and
supplying the on-site sensor with electricity from a lasting electric power source.
